(19) United States
(12) Patent Application Publication
(10) Pub. No.: US 2023/0227319 A1
(43) Pub. Date: Jul. 20, 2023

(54) PROCESS FOR SYNTHESISING A "ONE POT" HYDROPHOBIC SILICA AEROGEL FROM A SILICA PRECURSOR

(71) Applicant: KEEY AEROGEL, Schlierbach (FR)

(72) Inventors: Francisco-Manuel RUIZ-GONZALEZ, BALE (CH); Kanda PHILIPPE, GALFINGUE (FR)

(21) Appl. No.: 17/602,512

(22) PCT Filed: Apr. 9, 2020
(86) PCT No.: PCT/EP2020/060251

§ 371 Date: Feb. 22, 2022

(30) Foreign Application Priority Data
Apr. 10, 2019 (FR) FR1903843

(51) Int. Cl. C01B 33/158; C01B 33/155

(52) U.S. Cl. CPC C01B 33/1585; C01B 33/155; C01P 2004/03

(57) ABSTRACT

Disclosed is a simple, inexpensive method for preparing a hydrophobic silica aerogel by using a sodium silicate solution as a silica precursor.

### BACKGROUND OF THE INVENTION

### Field of the Invention

This invention concerns the synthesis of a silica aerogel with a ‘one-pot’ co-precursor.

### Description of the Related Art

Silica aerogels are nanoporous materials having an open-pore structure and excellent properties such as low density, controllable transparency, high porosity, and a large specific surface area, as well as low thermal conductivity. These properties are particularly interesting in numerous applications, in particular building construction and insulation. However, the structure of silica aerogels degrades over times due to the interaction between the OH groups on the Si atom and the hydrogen bond of water in a humid environment. This results in weakening or fragmentation of the structure.

In the field of thermal insulation, it is important for silica aerogels to have hydrophobic properties. There are essentially three techniques for making silica aerogels hydrophobic: methoxylation, silylation, and co-precursors (Anderson et al., 2011, Aerogel Book, Advances in sol-gel derived materials and technology, 47-77). These methods involve the replacement of a hydroxyl group with a hydrolytically unstable Si—R group, resulting in hydrophobic aerogels. Methoxylation consists of heating the hydrophilic aerogel in the presence of methanol vapour in order to convert the Si—OH groups into a Si—OCH₃ group. The main limitations of this technique relate to difficulties associated with the high temperatures that are necessary, as well as the dangerousness of the operating conditions.

Silylation involves modifying the surface of wet gels with various silylating agents before drying. Wet gels are prepared using standard solgel techniques, then solvent exchange and soaking the wet gels in a silylating agent. The disadvantages of this technique include its long duration and the resultant consumption of silylating agents and solvents.

Co-precursor methods involve replacing silica alkoxide precursors such as tetraethylorthosilicate (TEOS), tetramethylorthosilicate (TMOS), and other precursors, with a quantity of organosilanes such as methyltrimethoxysilane (MTMS) and trimethylthoxysilane (TMES), etc. This method is easy and requires minimal preparation time, but the cost of the alkoxide precursors and organosilanes presents an obstacle to its use on an industrial scale.

As such, there remains a need for a low-cost method for preparing hydrophobic silica aerogels.

### SUMMARY OF THE INVENTION

Such a method, by co-precursor synthesis by means of a low-cost silica precursor, is provided by this invention.

This method has several advantages and allows for cost reductions by reducing the alkoxide precursor and reducing the time needed for synthesis to a degree compatible with industrial-scale preparation.

Thus, in a first aspect, this invention concerns a method for preparing a hydrophobic silica aerogel by ‘one-pot’ synthesis using an aqueous silica precursor comprising the following mixtures of reagents, added simultaneously or sequentially:
ii) mixing the silica precursor, which is optionally pretreated by i) passing an aqueous solution of the silica precursor containing between 4 and 31 wt % SiO₂ through an ion exchanger resin; and one or more alcohols and adjusting it to a pH between 0 and 5;
iii) adding an organosilane;
iv) wet hydrophobic gelling in the presence of a basic solution as a catalyst; and
v) drying, in order to obtain the hydrophobic silica aerogel.

Preferably, the above steps are carried out in the following order: ii)-iii)-iv)-v).

Within the meaning of this invention, the term ‘one pot’ refers to the fact that the synthesis steps ii), iii), iv), and, optionally, i) occur in the same reactor, by simultaneous mixing of the various ingredients, or by sequential mixing. In one embodiment, the method comprises the prior step: i) of passing an aqueous silica precursor solution containing between 4 and 31 wt %, preferably 4 and 14 wt %, more preferably 4 and 8 wt% SiO₂ through an ion exchanger resin.

In one embodiment, the aqueous silica precursor is selected from sodium silicate solutions, colloidal silica solutions, silica solutions extracted from a silica-rich source such as building and demolition waste, waste from silica-based insulation material, glass, and mixtures thereof. Typically, the precursor solution is a silicate solution such as a sodium silicate solution.

Generally, the silica precursor solution contains between 4 and 8 wt % SiO₂, typically approximately 6 wt %, before passing through the ion exchanger resin.

Typically, the silicate solution contains approximately 6 wt % SiO₂.

‘Silicic acid’ refers to orthosilicic acid having the formula H₄SiO₄.

Examples of ion exchanger resins include resins having ionisable groups that are insoluble in the aqueous precursor solution and having the property of reversibly exchanging some of their H⁺ cations upon contact with the silicate counterions originating from the precursor solution. Thus, ion exchanger resins include cation exchanger resins, in particular Amberlite® resins such as the Amberlite® IR-120H+ resin.

At the output of the column, a silicic acid solution is obtained, which generally has the same concentration as the initial SiO₂ solution.

In one embodiment, the alcohol added to the silicic acid is selected from the group consisting of ethanol, methanol, isopropyl alcohol, and mixtures thereof.

The amount of alcohol generally depends on the desired properties of the aerogel; generally, the alcohol is added in an amount between 10 and 40 wt/vol % relative to the silicic acid solution.

The pH may advantageously be adjusted by adding an acid such as an inorganic acid. In one embodiment, the inorganic acid is selected from hydrochloric acid, nitric acid, sulphurous acid, and oxalic acid, and mixtures thereof. Typically, the concentration of the inorganic acid is between 0.1 and 2 mol.l⁻¹.

In one embodiment, the organosilane is selected from compounds of formula (I):

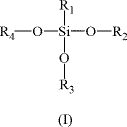

wherein each of the R₁ - R₄ groups is identical or different and independently selected from linear or branched C1-C12 alkyl groups and linear or branched C2-C12 alkenyl groups.

More specifically, the organosilanes is selected from methyltrimethoxysilane, methyltriethoxysilane, vinyltrimethoxysilane, isobutyltriethoxysilane, and isobutyltrimethoxysilane.

According to the invention, alkyl radicals represent saturated hydrocarbon radicals of 1 - 12 carbon atoms, preferably 1 - 5 carbon atoms, having straight or branched chains.

Examples of linear radicals include methyl, ethyl, propyl, butyl, pentyl, hexyl, octyl, nonyl, decyl, dodecyl, hexadecyl, and octadecyl radicals. Examples of radicals that are branched or substituted with one or more alkyl radicals include isopropyl, tert-butyl, 2-ethylhexyl, 2-methylbutyl, 2-methylpentyl, 1-methylpentyl, and 3-methylheptyl radicals.

Alkenyl radicals are C2-C12, in particular C2-C6, hydrocarbon radicals having straight or linear chains and comprising one or more ethylene unsaturations. Examples of alkenyl radicals include allyl or vinyl radicals.

In one embodiment, the wet gel comprises 1 - 50 wt % organosilane, in particular 1 - 15 wt %.

In a particular embodiment, the synthesis and gelling occur at a controlled temperature and pressure, generally between 15 and 30° C. and 1 and 200 bar, respectively.

In one embodiment, the aqueous basic solution is an ammonia solution, typically having a concentration between 0.1 and 2 mol.l⁻¹.

Generally, after being formed in step iv), the wet gel is subjected to ripening. Generally, this is carried out over a period of between 0 and 24 h.

After ripening, the gel may be washed. Generally, it is washed by means of an organic solvent such as an alcohol, more specifically ethanol.

Ripening and/or washing is generally carried out in controlled temperature and pressure conditions, typically at temperatures between 20 and 50° C. and pressures between 1 and 200 bars, respectively.

The wet gel may be prepared in any known-art form, e.g., as a monolith, granules, or a composite, with organic or inorganic fibres.

The gel is then dried. The drying step v) typically occurs by means of evaporation at ambient pressure or by reacting the reaction mixture obtained with one or more fluids under supercritical conditions in order to eliminate the organic solvent from the gel matrix without creating tension within the porous structure.

Generally, this may be done by low-temperature supercritical CO₂ drying (LTSCD).

In one exemplary embodiment, the preparation method comprises the following steps, either simultaneously or sequentially:
a) Preparing a silicic acid solution by passing a silicate solution through an ion exchanger resin;
b) Mixing the silicic acid solution with an organic alcohol;
c) Adjusting the pH of the mixture to a value between 0 and 5 by adding an anorganic acid;
d) Adding an organosilane at a concentration of 1 - 15 % of the reaction mixture;
e) Adding an ammonia solution at a concentration between 0.1 and 2 mol.l⁻¹;
f) Ripening and washing the gel obtained at controlled temperature and pressure;
g) Drying by means of LTSCD.

### BRIEF DESCRIPTION OF THE DRAWINGS

FIG. 1 is a schematic representation of the method for preparing a hydrophobic silica aerogel according to one embodiment of the invention.

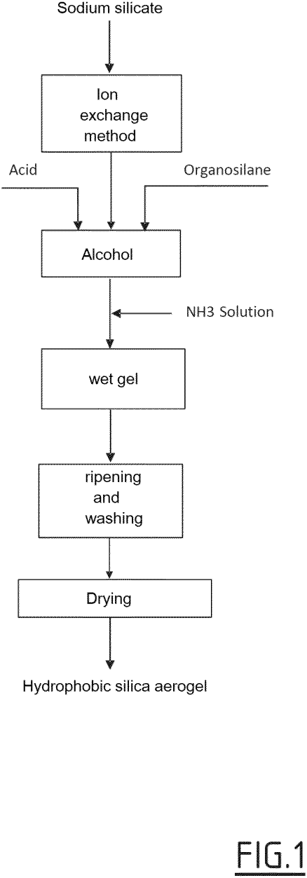

FIG. 2 is an SEM micrograph of a hydrophobic silica aerogel prepared according to one embodiment of the invention.

### DESCRIPTION OF THE PREFERRED EMBODIMENTS

The following examples are provided to illustrate this invention, without limiting its scope in any way.

### Example 1: Synthesis of a Silica Aerogel

30 ml of a sodium silicate solution (containing app. 27 wt % SiO₂) is diluted in 143 ml deionised water in order to obtain a sodium silicate solution containing app. 6 wt % SiO₂. Then, the sodium silicate solution is passed through an ion exchanger resin (Amberlite IR-120 H+) in order to eliminate the Na+ ions and obtain silicic acid. 130 ml silicic acid is mixed with 52 ml ethanol, and 1 ml hydrochloric acid (1 N) is then added. 18 ml of silylating agent (isobutyltriethoxysilane) is added and mixed. Following 1 h of stirring, 5 ml of an ammonia solution (1 N) is added, and gelling is carried out over 10 min. Following ripening and washing, the silica hydrogel is dried by LTSCD.

### Example 2: Properties

The hydrophobic silica aerogel obtained in Example 1 has the following characteristics:
Bulk density: 100 kg/m³
Contact angle: 130°
Thermal conductivity: 0.0157 W/m.K

Bulk density is defined by the ratio between mass and the volume of the geometrical envelope.

Measuring contact angles consists of measuring the angle formed by a drop of water at its point of contact with the surface of a solid (the sample) and the gaseous phase (here, the atmosphere). The device used to measure contact angles is a Digidrop goniometer.

Flow measurement is used to measure thermal conductivity. Two plates on either side of the sample may be heated or cooled, allowing for precise determination of the temperature difference between the hot plate and the cold plate. A data acquisition system allows for the development of flows and temperatures to be monitored and the thermal conductivity to be determined.

Microscopic observation was carried out by means of a scanning electronic microscope (Philips, XL30).

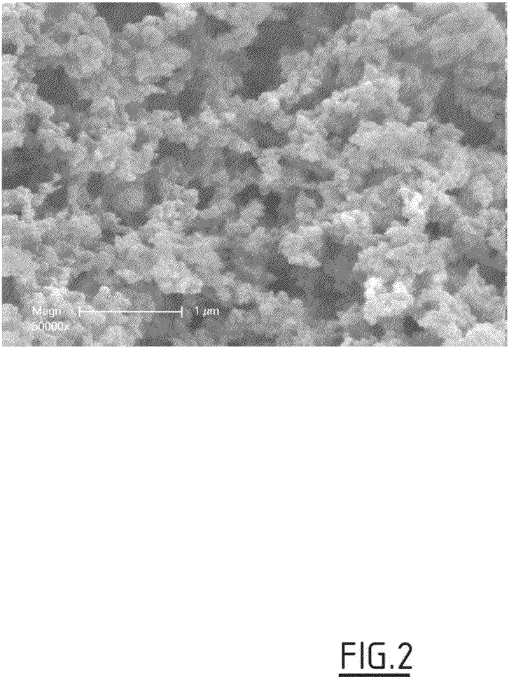

The nanostructure of the hydrophobic silica aerogels obtained is shown in FIG. 2.

1. A method for preparing a hydrophobic silica aerogel by ‘one-pot’ synthesis using an aqueous silica precursor, comprising the following steps:
i) mixing the silica precursor, and one or more alcohols and adjusting the mixture to a pH between 0 and 5;
ii) adding an organosilane;
iii) wet hydrophobic gelling in the presence of a basic solution as a catalyst; and
iv) drying, in order to obtain the hydrophobic silica aerogel.

2. The method according to claim 1, such that the aqueous silica precursor is selected from sodium silicate solutions, colloidal silica solutions, silica solutions extracted from a silica-rich source, waste from silica-based insulation material, glass, and mixtures thereof.

3. The method according to claim 1, such that the aqueous precursor solution contains between 4 and 8 wt % SiO₂.

4. The method according to claim 1, such that the alcohol is selected from the group consisting of ethanol, methanol, isopropyl alcohol, and mixtures thereof.

5. The method according to claim 1, such that the pH adjustment is carried out by adding an inorganic acid selected from hydrochloric acid, nitric acid, sulphurous acid, and oxalic acid, and mixtures thereof.

6. The method according to claim 5, such that the concentration of the inorganic acid is between 0.1 and 0.2 mo1.1⁻¹.

7. The method according to claim 1, such that the organosilane is selected from compounds of formula (I): 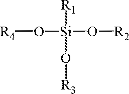
wherein each of the R₁ — R₄ groups is identical or different and independently selected from linear or branched C1-C12 alkyl groups and linear or branched C2-C12 alkenyl groups.

8. The method according to claim 1, such that the organosilane is selected from methyltrimethoxysilane, methyltriethoxysilane, vinyltrimethoxysilane, isobutyltriethoxysilane, and isobutyltrimethoxysilane.

9. The method according to claim 1, such that the organosilane is included in the amount of 1 - 50 wt % of the wet gel.

10. The method according to claim 1, such that the synthesis and gelling are carried out at a controlled temperature and pressure between 15 and 30° C. and 1 and 200 bar, respectively.

11. The method according to claim 1, such that the basic solution is an ammonia solution having a concentration between 0.1 and 2 mol.l⁻¹.

12. The method according to claim 1, such that ripening and/or washing is carried out prior to contacting the wet gel with a supercritical fluid.

13. The method according to claim 12, such that the washing is carried out with ethanol at a temperature and pressure between 20 and 50° C. and 1 and 200 bar, respectively.

14. The method according to claim 1, such that the wet gel is prepared in the form of a monolith, granules, or composite with organic or inorganic fibres.

15. The method according to claim 1, such that the drying is carried out at ambient pressure or in one or more fluids in supercritical conditions.

16. The method of claim 1, wherein prior to mixing the silica precursor, the silica precursor is pretreated by passing an aqueous solution of the silica precursor containing between 4 and 31 wt % SiO₂ through an ion exchanger resin.

17. The method according to claim 2, such that the alcohol is selected from the group consisting of ethanol, methanol, isopropyl alcohol, and mixtures thereof.

18. The method according to claim 3, such that the alcohol is selected from the group consisting of ethanol, methanol, isopropyl alcohol, and mixtures thereof.

19. The method according to claim 2, such that the pH adjustment is carried out by adding an inorganic acid selected from hydrochloric acid, nitric acid, sulphurous acid, and oxalic acid, and mixtures thereof.

20. The method according to claim 3, such that the pH adjustment is carried out by adding an inorganic acid selected from hydrochloric acid, nitric acid, sulphurous acid, and oxalic acid, and mixtures thereof.
